(19) United States
(12) Patent Application Publication
(10) Pub. No.: US 2009/0055395 A1
(43) Pub. Date: Feb. 26, 2009

(54) Method and Apparatus for XML Data Processing

(75) Inventors: Robert C. W. Jenks, McKinney, TX (US); Hong Zhang, The Colony, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/197,841

(22) Filed: Aug. 25, 2008

Related U.S. Application Data
(60) Provisional application No. 60/957,981, filed on Aug. 24, 2007.
(60) Provisional application No. 60/969,165, filed on Aug. 31, 2007.

(51) Int. Cl. G06F 7/06; G06F 17/30

(52) U.S. Cl. 707/6; 707/E17.014

(57) ABSTRACT

Method and apparatus for at least one of coding or decoding of data. The method comprising retrieving Extensible Markup Language (“XML”)-Unicode Transformation Format 8 (“UTF-8”) data, confirming XML-UTF-8 data in a proper format converting a prolog located within said XML-UTF-8 data, initializing a tag and attribute lookup table, comparing a current character to a plurality of multi-character patterns, determining whether said current character can be converted to a multi-character pattern in said plurality and Unicode, converting said current character to one of ASCII and Unicode when said current character cannot be converted to said multi-character pattern in said plurality, comparing at least one subsequent character to said plurality of multi-character patterns to determine conversion of at least the current character when said current character can be converted more than one way, determining whether there are more characters.

### CROSS-REFERENCE TO RELATED APPLICATIONS

This application claims benefit of U.S. provisional patent application Ser. No. 60/957,981, filed Aug. 24, 2007, and U.S. provisional patent application Ser. No. 60/969,165, filed Aug. 31, 2007, which are herein incorporated by reference.

### BACKGROUND

1. Field of the Invention

Embodiments of the present invention generally relate to data manipulation. More specifically, the present invention relates to a method and apparatus for compression and/or decompression of Extensible Markup Language (“XML”)-Unicode Transformation Format 8 (“UTF-8”) data of XML UTF-8 data.

2. Description of the Related Art

There are many data compression and encoding methods and apparatus known today. Due to the ever-increasing need to transmit and store large amount of data, there is continued demand for improving data compression and decompression. Such compression improves speed of data manipulation and reduces memory requirements.

Currently, some methods are based on storage of recurring strings in tree form, which requires adding a new “leaf” node with the occurrence of a string not previously encountered. Other methods utilize a “sliding window” data compression, in which compression is achieved by comparing a certain string to be compressed to earlier portions of the string and reproducing the current string merely by referring to any similar earlier portions of the string found by the comparison. The string compression methods generally have a high compression ratio; however, such methods use a great deal of processor resources and memory to compress data at a reasonably fast rate. As a result, the resulting compressed file may be larger than the original uncompressed file.

ASCII contains 127 different character codes, which may represent alphanumeric characters used in the English language and others. Since Unicode encompasses different languages, it contains more than 65,000 character codes. Hence, usually Unicode represents almost every character that can be included in a document. In an effort for compatibility with ASCII, Unicode Transformation Format 8 (“UTF-8”) reserved the first 127 characters for ASCII and the rest for Unicode. However, UTF-8 tends to waste space, for example, by using more bytes to represent characters than needed.

Therefore, there is a need to compress and/or decompress data in a way that would not require a great deal of processing power and that can be utilized with limited resources. Thus, there is a need for an improved method and apparatus for data compression and/or decompression.

### SUMMARY

Embodiments disclosed herein generally relate to a method and an apparatus for at least one of coding or decoding of data. The method comprising retrieving Extensible Markup Language (“XML”)-Unicode Transformation Format 8 (“UTF-8”) data, confirming XML-UTF-8 data in a proper format converting a prolog located within said XML-UTF-8 data, initializing a tag and attribute lookup table, comparing a current character to a plurality of multi-character patterns, determining whether said current character can be converted to a multi-character pattern in said plurality and Unicode, converting said current character to one of ASCII and Unicode when said current character cannot be converted to said multi-character pattern in said plurality, comparing at least one subsequent character to said plurality of multi-character patterns to determine conversion of at least the current character when said current character can be converted more than one way, determining whether there are more characters.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A depicts an embodiment of encoding sheet;

FIG. 1B depicts embodiment of encoded data of FIG. 1A;

FIG. 2 is an embodiment of flow diagram of an encoding method;

FIGS. 3A and B depict an embodiment of a flow diagram of a method for the tag and attribute lookup table utilized in FIG. 2;

FIGS. 4A and B depict an embodiment of a flow diagram of a process content method of a tag and attribute lookup table method of FIG. 3A and B;

FIGS. 5A and B depict an embodiment of a method for decoding XML UTF-8 prolog, tag(s), and/or attribute(s);

FIGS. 6A and B depict an embodiment of a flow diagram of a method 600 for decoding and/or decompressing encoded data; and

FIG. 7 depicts an exemplary high-level block diagram of coding/decoding computer system.

### DETAILED DESCRIPTION

The present invention generally relates to data compression and more specifically to a method and apparatus for compression and/or decompression of Extensible Markup Language (“XML”)-Unicode Transformation Format 8 (“UTF-8”) data (double compression and/or double decompression).

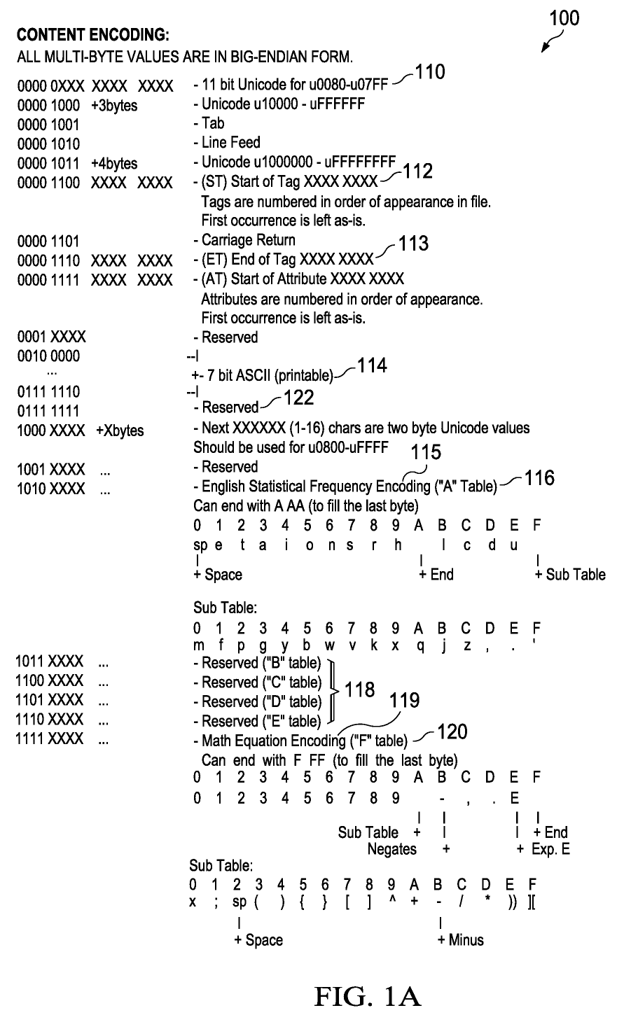

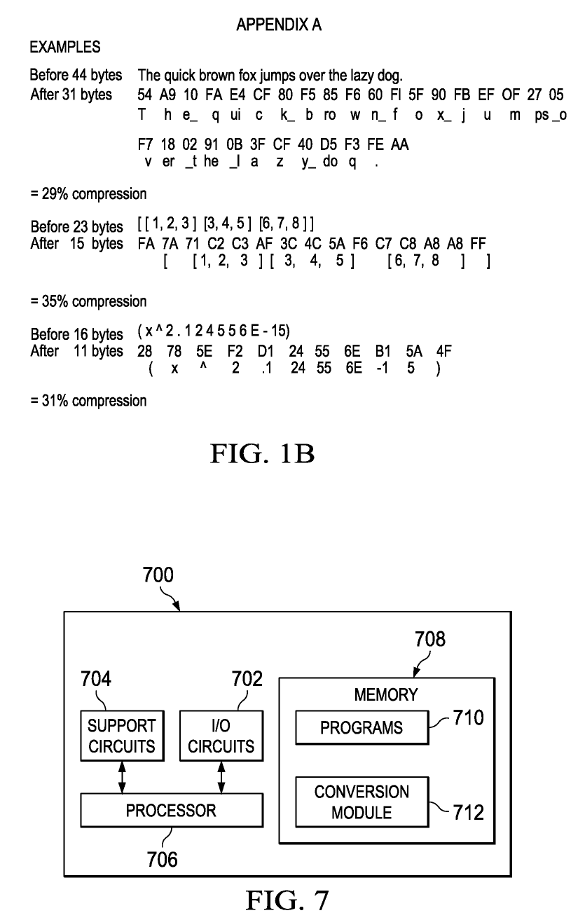

FIG. 1A depicts an embodiment of encoding sheet 100. Encoding sheet 100 separates characters into different patterns for the purpose of encoding (i.e., compressing and decompressing) those characters. Encoding sheet 100 includes several columns of bytes. The first two columns are each nibbles in a command byte. The additional columns represent nibbles of data which follow the command byte.

The number of additional bytes available depends upon the pattern which a character (or string of characters) falls into. For example, some of the multi-character patterns are characterized as follows: Math Equation Encoding, such as, Table “F” 120; Reserved, such as, tables “B,” “C,” “D,” and “E” 118, English Statistical Frequency Encoding, such as, “Table “A” 116”, ASCII 114, Unicode 110, Tags 112 and Attributes 113. Some patterns include sub-patterns. For example, the English Statistical Frequency Encoding 115 and Math Equation Encoding 119 patterns include sub-patterns.

FIG. 1A also includes “RESERVED” command bytes for future expansion. For example, FIG. 1A includes Reserved Tables “B”, “C”, “D”, and “E” 118. When, in the future, these tables are utilized, a string of characters that fall within these tables will begin with the letter identifying that table, for example, the encoded string will begin with a “B” and end with a “B” (or “BB” as explained below with respect to Table “A”). Further, the maximum number of bytes, in addition to the command byte, has not provided because the byte allocation will depend in part on the type of characters in that table. In addition, FIG. 1A also includes reserved command bytes “0001 XXXX”, “0111 1111”, and “1001 XXXX” for future use.

FIG. 1B depicts embodiment of encoded data of FIG. 1A. The second and third examples contain numeric characters and a comparison to the multi-character patterns indicates that Math Equation Encoding Table “F” 119 (shown in FIG. 1A) is used. Encoding using Table “F” is similar to that described above with respect to Table “A”. In various embodiments, the encoding can also recognize adjacent parenthesis or adjacent brackets. One way, when either a parenthesis or bracket is detected to check the immediate subsequent character and use a use a nibble to represent the adjacent brackets or adjacent parenthesis.

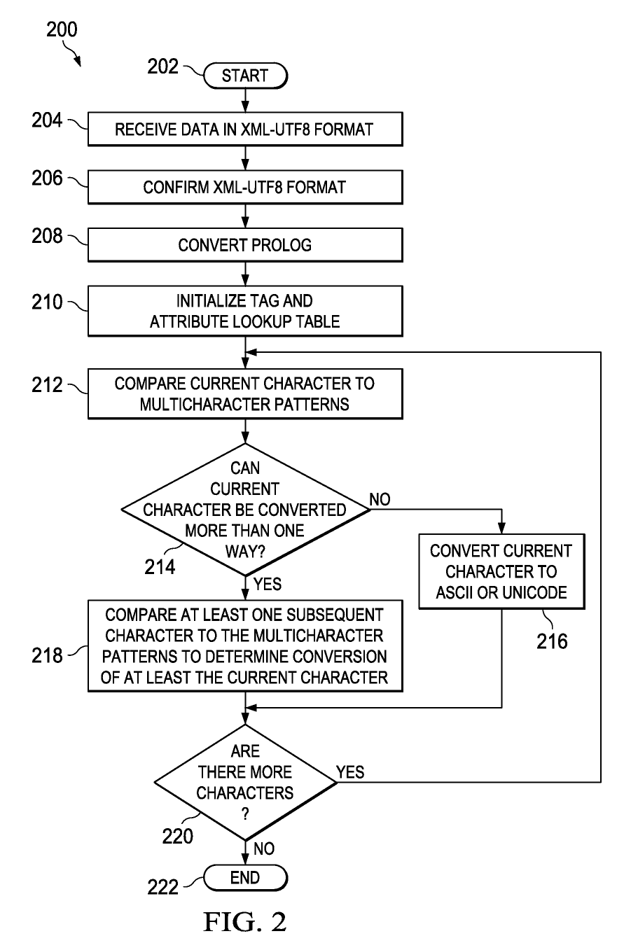

FIG. 2 is an embodiment of flow diagram of an encoding method 200. The method 200 begins at step 202 and proceeds to step 204. At step 204, a device, for example, a handheld device (such as, a handheld calculator), a computer (such as, a desktop personal computer), or the like, receives data in the XML UTF-8. Thereafter, the method 200 proceeds to step 206. At step 206, the method 200 confirms that the data received in step 204 is in XML-UTF8 format.

For example, the method 200 reviews the received data and its format contained in the XML prolog. If the prolog's information format and/or the information contained therein are correct, then the method 200 determines that the data is in the XML-UTF8 format. The format for an XML UTF-8 prolog is strict and usually begin with a “<” and ending with a “>” sign. More specifically, the proper format is usually as follows:

<?xml version=“1.0” encoding=“UTF-8”?> . . . Example 1 which indicates the version of XML used is version 1 and that it is encoded in the UTF-8 format. Thereafter, the method 200 proceeds to step 208.

At step 208 the prolog is converted to reduce storage space. In Example 2 below, the prolog of Example 1 is shown before conversion and is juxtaposed with the prolog after conversion.

Before: <?xml version=“1.0” encoding=“UTF-8”?>

After: TIXC0100-1.0?> . . . Example 2 where TIXC0100 indicates that it is Texas Instruments Incorporated XML compression version number; in the instant case, it is version 1 (01 major and 00 minor) followed by a hyphen, and 1.0 to indicates the version of XML taken verbatim from the prolog, and ending with the “greater than” sign. After inspection of material above, it is noted that the number of characters utilized by the prolog after conversion is smaller. After conversion of the prolog, the method 200 proceeds to step 210.

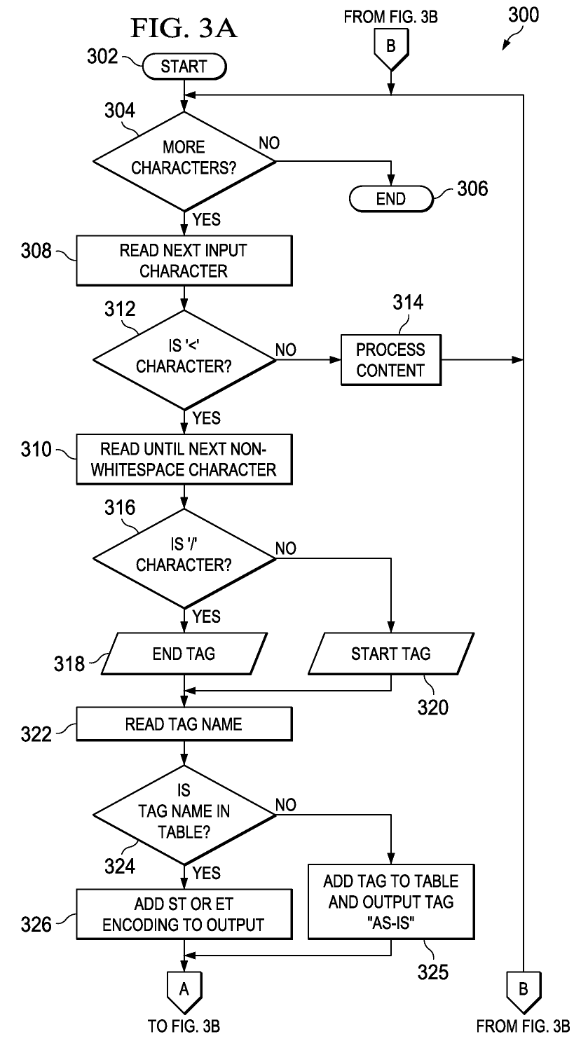

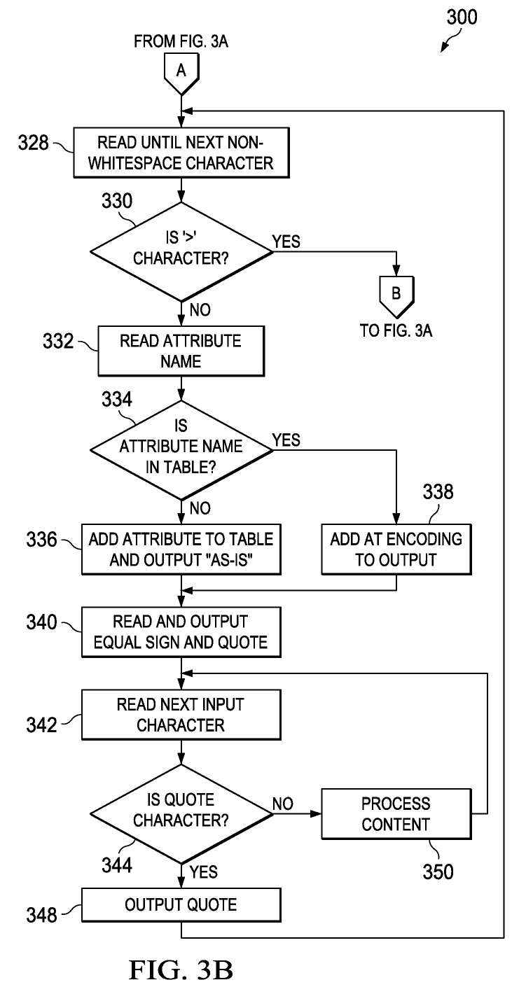

At step 210, a lookup table is initialized to store XML tag(s) and attributes. Typically, the lookup table contains 256 addresses (numbered 0-255) for storage of the XML tags and attributes. The tags and attributes are stored during their first occurrence and when that tag and attribute occur later, the address location is used to refer to the subsequent occurrence(s), for example, at the occurrence of the end tag. Greater detail regarding the initialization and storage of tags and attributes in the lookup table is provided in FIGS. 3A and B. After the lookup table has been initialized, the method 200 proceeds to step 212.

At step 212 an XML character is compared to the multi-character patterns of FIG. 1A. The first character is examined to determine whether it falls within any of the multi-character patterns, such as, Table “A”. Referring to one of the examples in FIG. 1B, “The quick brown fox jumps over the lazy dog.” The first character “T” is referred to as the current character. At step 212, “T” is compared to the multi-character patterns in FIG. 1A to see if the character “T” falls within any of these patterns. After comparison of that character with the multi-character patterns, the method 200 proceeds to step 214.

At step 214, the method 200 uses the results of the comparison in step 212 and queries whether the current character can be converted in more than one way. As used herein, “more than one way” refers to conversion to any one of the multi-character patterns in FIG. 1A, ASCII, Unicode code and the like. The character “T” does not fall within any of the multi-character patterns in FIG. 1A. As a result, the query at step 214 is answered negatively and the method 200 proceeds to step 216.

At step 216, the current character is converted, for example, compressed into binary form, to ASCII or Unicode. In the current example, “T” is 54. After conversion, the method 200 proceeds to step 220. At step 220, method 200 determines whether there are more characters in the string. If there are more characters, the method proceeds to step 212; otherwise, the method proceeds to and ends at step 222.

In the current example, the next character is “h” and is labeled the current character. The current character “h” is found in Table “A” as 9 and can also be found in the 7 bit ASCII (printable) section as 68. After comparison, the method proceeds towards step 214.

At step 214, the method 200 determines whether the current character “h” can be converted in more than one way. In this instance, the current character can be converted; hence, the method proceeds to step 218.

At step 218, the method 200 compares at least one subsequent character to the multi-character patterns to determine which of the available ways to encode the current character “h” is best. The next subsequent character in the example is “e.” The subsequent character “e” can also be converted using either Table “A” as 1 or under the 7 bit ASCII as 65. In other embodiments, subsequent characters are reviewed to determine how to code or encode the current character “h” or the entire string of characters. After comparison, at least the character “h” is encoded using scheme of Table “A.” Since “h” is the first character encoded using Table “A” and after “T” is encoded as 54, “h” is encoded as “A9” and not just “9.” In addition, the number of subsequent characters used to determine how to encode the current character can be any length, for example, up to the first non multi-character pattern or character that can be encoded in one way.

When using a tale, the multi-character tables usually begins and ends with a character indicative of using that table. If there is one character in the string, then that character is encoded using the 7 bit ASCII encoding section. For example, when using Table “A” the first character in the string, which uses the table, is an “A” and the last in the string is an “A” (or an “AA” to fill the last byte). The more characters that are encoded using one of the multi-character tables, the more efficient is the compression. Usually the string “The quick brown fox jumps over the lazy dog.” is 44 bytes long. However, the same string after compression is 31 bytes. Other than “T”, the remaining characters use Table “A” because the remaining characters in the string are lower case alphanumeric characters. Hence the characters encode as follows: “e” is encoded as 1, a space between “e” and “q” is encoded as 0, and the character “q” is found in the sub-table of Table “A.”

Accordingly, a nibble indicating a character in the sub-table is selected; in Table “A”, the nibble is “F”. Therefore, “q” is encoded FA. As a result, encoding a character from the sub-table of Table “A”, an “F” may precede such a character from the sub-table. Encoding of the example proceeds as indicated above. Since the encoding uses Table “A”, the end of the encoding includes at least an “A” indicating the end of the string. However, using a single “A” may result in an incomplete byte. As a result, an “AA” may be used. The method 200 proceeds to step 220.

At step 220 the method queries whether there are more characters to encode. If are not more characters to encode, the method 200 proceeds to and ends at step 222. Otherwise, the method 200 proceeds to step 212, wherein each subsequent character becomes the new current character for analysis.

FIGS. 3A and B depict an embodiment of a flow diagram of a method 300 for the tag and attribute lookup table utilized in step 210 depicted in FIG. 2. The method 300 begins at step 302 and proceeds to step 304. Step 304 is a step used to determine whether there are more characters in a character string. If there are no more characters, the method proceeds to and ends at step 306. Otherwise, the method 300 proceeds to step 308.

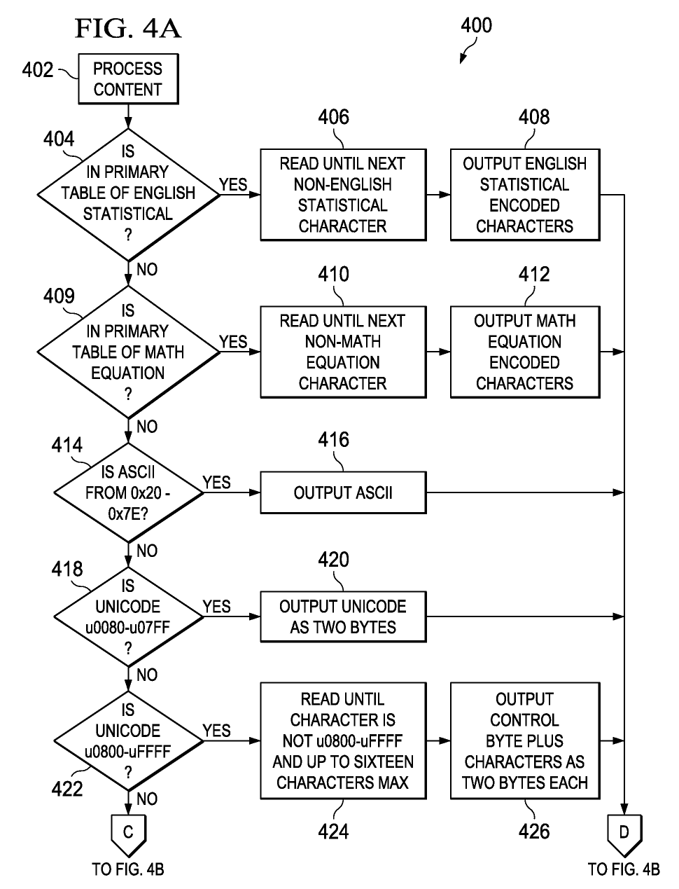

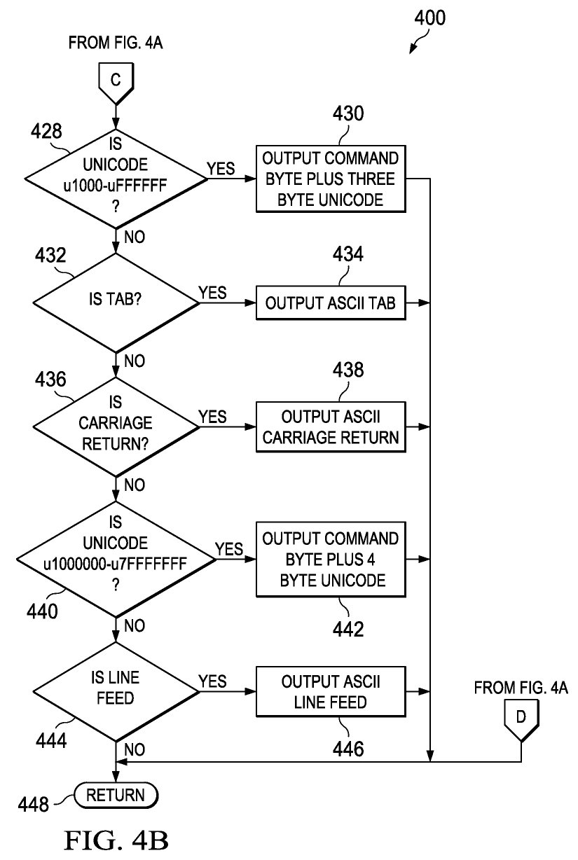

At step 308, a character in the string is read. The method 300 proceeds to step 312. At step 312, a determination is made whether that character is a “<”. Because the format of a tag in XML UTF-8 is usually strict, if the first character is not a “<”, then the character string is not a tag and is non tag XML UTF-8 data. If the character is not “<”, the method proceeds to step 314. At step 314, the character is processed for encoding. More detail regarding the encoding of the character is described in FIGS. 2 and 4. After the content is processed in step 314, the method 304 returns to step 304.

If the character is “<”, the method 300 proceeds from step 312 to step 310. In XML UTF-8 there may be character space(s) between the “<” and the first non-whitespace character. When the first non-whitespace character is read, the method 300 proceeds to step 316. White-space is defined herein as spaces, tabs, and carriage returns. Depending on where the white-space is positioned, the compression scheme will ignore the white-space. For example, if the white-space is between a “<” and a tag name, the white-space is ignored (<cat name=“biggles”>female</cat>). In this example, the white-space between “<” and “cat” is ignored. However, white-space in non-tag data is not ignored.

At step 316, the method 300 determines whether the first non-whitespace character is a “/”. Tags begin and end with a “<”. However, a “/” is immediately after an end tag “<”. If the first non-whitespace character is not a “/”, then the “<” is a start of the tag. If the first non-whitespace character is not a “/”, the method 300 proceeds to step 320, wherein the method 300 determines the start tag, The method 300 proceeds from step 320 to step 322. If the first non-whitespace character is a “/”, then the “<” is an end tag and the end tag is marked in step 318. The method 300 proceeds from step 318 to 322.

At step 322, the tag name is read and the method proceeds to step 324. At step 324, the method 300 determines whether the tag name is in a look-up table. If the tag name is not in the look-up table, the method proceeds to step 325. At step 325, the method determines that this is the first time that the tag has been read and the tag is added to the next available address in the look-up table. In addition, at step 325, the method 300 outputs the tag “as is”, for example, uncompressed. After step 325, the method proceeds to step 328.

If the tag is in the look-up table, the method 300 proceeds to step 326. At step 326, a start tag (“ST”) or end tag (“ET”) is encoded to the output. Encoding of the ST and ET are described in FIG. 1A. For example, encoding of the first ST is “0000 1100 0000 0000”, where the first two nibbles are the command byte indicating a start of tag and the third and fourth nibble indicate that the first ST is in the first address, such as, address “0”. An end tag would be “0000 1110 0000 0001”, where the first two nibbles are the command byte for an end of tag and the third and fourth nibbles indicate that the ET is stored in the second address, such as, address “1”. The look-up table may contain 256 addresses (numbered 0 through 255), which store the tag and attributes. Thereafter, the method 300 proceeds to step 328. At step 328, the method 300 reads characters until the next non-whitespace character is found. When the next non-whitespace character is found the method 300 proceeds to step 330.

At step 330, the method 300 determines whether the non-whitespace character is a “>”. If the non-whitespace character is a “>”, an attribute does not follow the “>” and the method returns to step 304. If the non-whitespace character is not an “>”, then the character is the first character in an attribute and the method 300 proceeds from step 330 to step 332.

At step 332, the attribute name is read. At step 334, the method 300 determines whether the attribute is already stored in the look-up table. If the attribute is not already in the look-up table, the method 300 proceeds to step 336. At step 336, the attribute is added to the look-up table and is stored “as is”, for example, without compression and the method proceeds to step 340. Otherwise, the method 300 proceeds to step 338, wherein the storage location of the attribute is encoded to output. For example, if the first tag had an attribute stored in the look-up table, the encoding would be of FIG. 1A “0000 1111 0000 0000”, where the first two nibbles are the command byte indicating a start of an attribute and the last two nibbles are the address location of the attribute in the look-up table. The method 300 proceeds from step 338 to step 340.

At step 340, the output is generated with the addition of an equal sign (“=”) and a quote (“””). Thereafter, the method proceeds to step 342.

At step 342, the next character is read. The method 300 proceeds to step 344. At step 344, the method 300 determines whether the next character is a quote. If the next character is not a quote, the method 300 proceeds to step 350, wherein content of the data is encoded (see FIGS. 4A and B and method 400). If the character is a quote, the method 300 proceeds to step 348. At step 348, the method 300 outputs the quote (to indicate the end of the attribute) and the method 300 returns to step 328. The process content of steps 314 and 350 may be the same process content.

The method 300 proceeds from steps 314 and/or 350 to method 400. FIGS. 4A and B depict an embodiment of a flow diagram of a process content method 400 for the tag and attributes lookup table method of FIGS. 3A and B. In method 400, a series of comparisons are made between the characters and the types of encoding of FIG. 1A to determine how to encode the character(s), wherein such encoding would maximize compression. The method 400 begins at step 314 and proceeds to step 404.

At step 404, the method 400 determines whether a character is contained within Table “A”. If the character is contained within Table “A”, the method 400 proceeds to step 406. At step 406, characters are read until the next non-English Statistical character, such as, a character not in Table “A”, is found. Thereafter, the method proceeds to step 408, wherein the method 400 outputs English statistical encoded characters. From step 408, the method proceeds to step 448, wherein the method 400 returns to method 300. If the character is not contained with Table “A”, the method 400 proceeds from step 404 to step 409.

At step 409, a determination is made whether the character is in a primary table of math equation, for example, in Table “F”. If the character is in a primary table of math equation, the method 400 proceeds to step 410. Otherwise, the method 400 proceeds to step 414. At step 410, characters are read until the next non-mathematical equation character is found and the method 400 proceeds to step 412. At step 412, the mathematical sequence is encoded using Table “F” and the method 400 proceeds to step 448.

At step 414, the method 400 determines whether the character falls within the 7 bit ASCII 112 range. If the character falls within the 7 bit ASCII 112 range, the character is encoded as ASCII, for example, an upper case English character. The method 400 proceeds to step 448. If the character does not fall within the 7 bit ASCII 112 range, the method 400 proceeds to step 418.

At step 418, the method 400 determines whether the character is within the Unicode u0080-u07FF range (for example, “0000 0XXX XXXX XXXX”). Since the range of characters that fall into this character is considerably large, the scheme allocates 11 bits for the encoding of the character. If the character is within the Unicode u0080-u07FF range, the method 400 proceeds to step 420, wherein the character is encoded as two bytes. From step 420, the method 400 proceeds to step 448. If the character is not within the Unicode u0080-u07FF range, the method 400 proceeds to step 422.

At step 422, the method 400 determines whether the character falls within Unicode u0800-uFFFF range (from FIG. 1A, “1000 XXXX+Xbytes”). If whether the character falls within Unicode u0800-uFFFF range, the method 400 proceeds to step 424 until it is not in the u0800-uFFFF range and up to 16 characters maximum. The method 400 proceeds from step 424 to step 426. At step 426, the method 400 outputs control byte (“1000 XXXX”) plus the encoded characters (at two bytes each). Thereafter, the method proceeds to step 448. If the character does not fall within Unicode u0800-uFFFF range, the method 400 proceeds to step 428.

At step 428, a determination is made whether the character falls within Unicode u10000-uFFFFFF (as depicted in FIG. 1A, “0000 1000 XXXX XXXX XXXX XXXX XXXX XXXX” also referred to herein as +3 bytes). If the character falls within Unicode u10000-uFFFFFF, the character is encoded, at step 430, with the command byte (“0000 1000”) plus 3bytes encoded in Unicode. Note that prior to encoding, there were 4 or 5 bytes of UTF-8 and after encoding the output is 4 bytes long. After encoding, the method proceeds to step 448. If a negative determination is made at step 428, the method proceeds to step 432.

At step 432, the method 400 determines whether the character is a tab, such as, white-space. If character is a tab, the method 400 proceeds to step 434, wherein the character is encoded in ASCII. After encoding of the tab, the method proceeds to step 448. If the character is not a tab, the method 400 proceeds to step 436.

At step 436, the method 400 determines whether the character is a carriage return, for example, white-space. If the character is a carriage return, the method proceeds to step 438, wherein the character is encoded in ASCII. After encoding of the carriage return, the method 400 proceeds to step 448. If the character is not a carriage return, the method 400 proceeds to step 440.

At step 440, the method 400 determines whether the character falls within u1000000-u7FFFFFFF (“0000 1011+4 bytes”), where “0000 1011” is the command byte and the “+4 bytes” is the range of possible characters that can be encoded. If the character falls within u1000000-u7FFFFFFF, the method 400 proceeds to step 442, wherein the command byte plus the 4 byte Unicode is output. Note that prior to encoding the character was 5 or 6 bytes of UTF-8 and after encoding the output is 5 bytes long. After encoding, the method 400 proceeds to step 448. If the character does not fall within u1000000-u7FFFFFFF, the method 400 proceeds to step 444.

At step 444, the method 400 determines whether the character is a line feed. If the character is a line feed, the line feed is encoded in ASCII and the method 400 proceeds to step 448. If the character is not a line feed, the method 400 proceeds to step 448, wherein the method 400 returns to method 300.

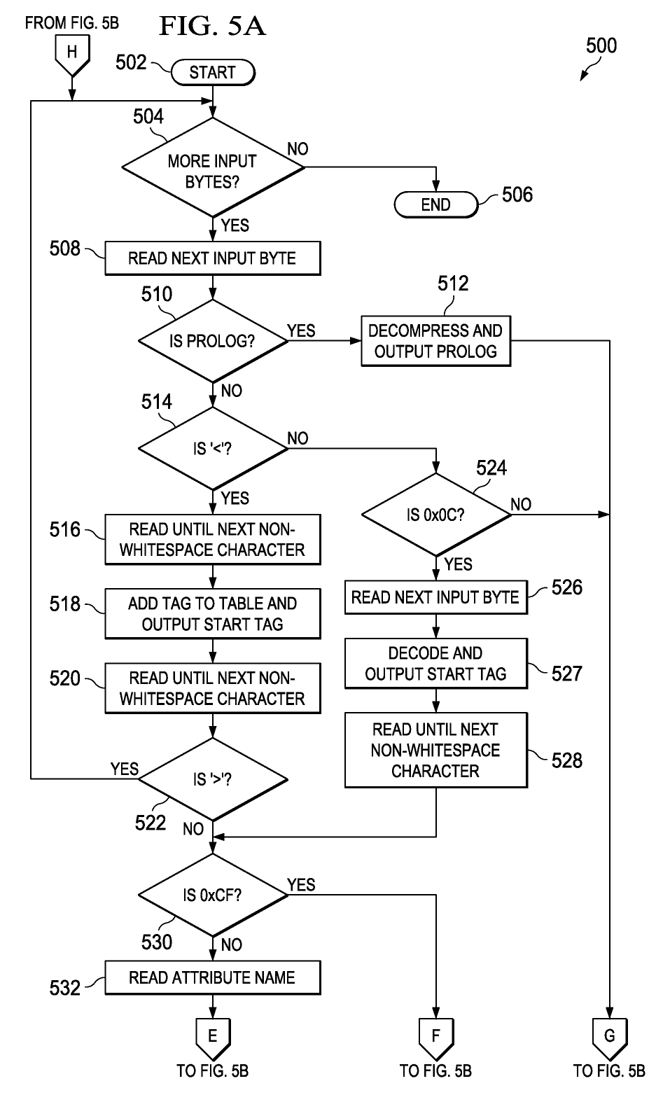

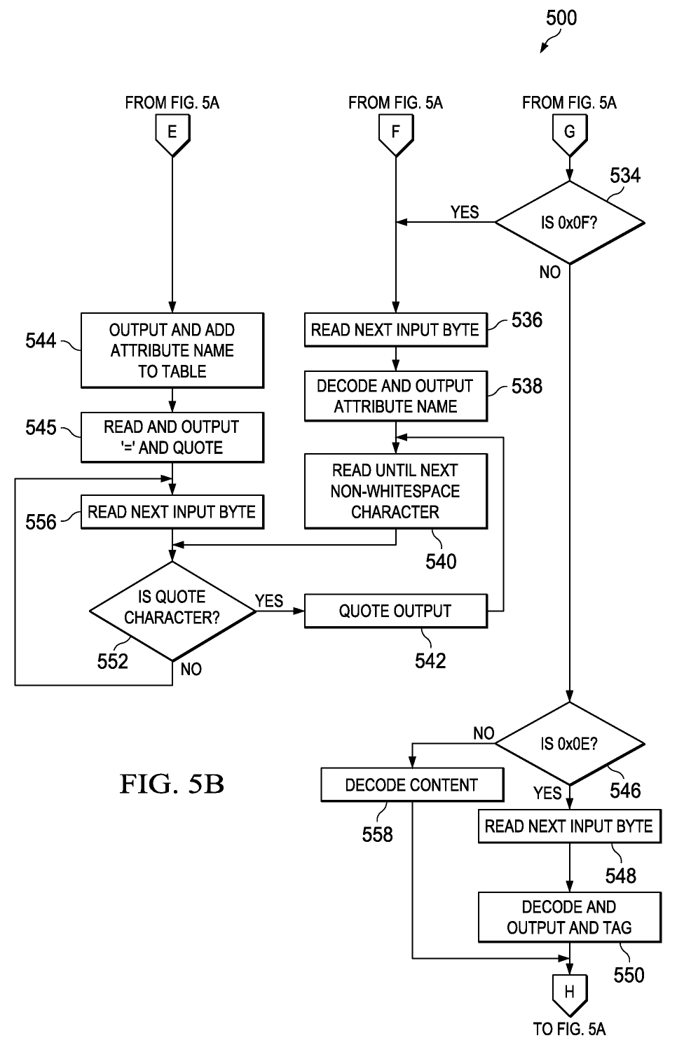

FIGS. 5A and B depict an embodiment of a method 500 for decoding XML UTF-8 prolog, tag(s), and/or attribute(s). The method 500 begins at step 502 and proceeds to step 504. At step 504, the method 500 determines whether there is an input for decoding. If there is no input to decode, the method 500 proceeds to and ends at step 506. However, if there is an input to decode, the method 500 proceeds to step 508.

At step 508, the next available input byte is read and the method 500 proceeds to step 510. At step 510, the input byte is analyzed to determine whether it is an encoded XML UTF-8 prolog (i.e., is it in the form of “TIXC0100-1.0?>”). If the input byte is encoded XML UTF-8 prolog, the method proceeds to step 512. At step 512, the encoded prolog is decompressed and the method 500 proceeds to step 504. If the input byte is not encoded XML UTF-8 prolog, the method proceeds to step 514.

At step 514, the method 500 determines whether the input byte is an (indicative of the beginning of a tag). If the input byte is an “<”, the method 500 proceeds to step 516. At step 516, input bytes are read until a non-whitespace character is detected. When the non-whitespace character is detected, the method 500 proceeds to step 518. At step 518, the tag is added to a look-up table (for recreation of the look-up table created during encoding) and start tag is outputted. At step 520, characters are read until the next non-whitespace character is detected. A step 522, method 500 determines whether the non-whitespace character found in step 520 is a “>”. If the non-whitespace character found in step 520 is a “>”, the method proceeds to step 504. Otherwise, the method proceeds to step 530.

At step 530, the method 500 determines whether the character is the start of an attribute (indicated by “0×0F”). If the character is not the start of an attribute, the character is part of an attribute name and the method proceeds to step 532. If the character is the start of an attribute, the method proceeds to step 536.

At step 532, the name of the attribute name is read and the method 500 proceeds to step 544. At step 544, the attribute name is stored in the look-up table and outputted as is (the first occurrence, which was not encoded). Thereafter, the method proceeds to step 545.

At step 545, the attribute name is read and an “=” and quote are added to the end of the attribute name, which reconstructs the attribute and comply with the XML UTF-8 format. The next byte is read at step 556 and thereafter, the method 500 proceeds to step 552. The presence of a quote indicates the end of an attribute.

At 552, the method 500 determines if there exists a quote character. If there is a quote character, the method 500 proceeds to step 558, wherein the content, such as, non attribute data, is decoded in method 600. Otherwise, the method 500 proceeds from step 552 to step 542, wherein the quote is outputted. After step 542, the method proceeds to step 540. At step 540, characters in the string are read until the next non-whitespace character is detected. Method 500 proceeds to step 552 when the non-whitespace character is detected.

If input byte is not an “<” at step 514, the method proceeds to step 524. At step 524, the command byte is examined to determine whether there is a start of tag (“0×0C”). If there is a there is a start of tag, the method proceeds to step 526. At step 526, the next input byte is read. At step 527, the next byte is decoded and outputted as the start of the tag. Thereafter, the method proceeds to step 528 to read characters until the next non-whitespace character is detected. After detection of a non-whitespace character is detected, the method proceeds to step 530.

Returning to step 524. If input byte is not an “<” step 524, the method 500 proceeds to step 534. At step 534, the method determines whether the command byte is indicative of a start of attribute (“0×0F”). If the command byte is indicative of a start of attribute, thus, there may be an encoded attribute name, the method 500 proceeds to step 536. If the command byte is not indicative of a start of attribute merely indicates, then the attribute may not have been encoded, such as, the first occurrence of that attribute.

At step 536, the next input byte is read. The next byte provides the location of the attribute in the look-up table. After the byte is read, the method proceeds to step 538, wherein the attribute is located in the look-up table, decoded, and output as the name of the attribute associate with that location. Thereafter, the method 500 proceeds to step 540.

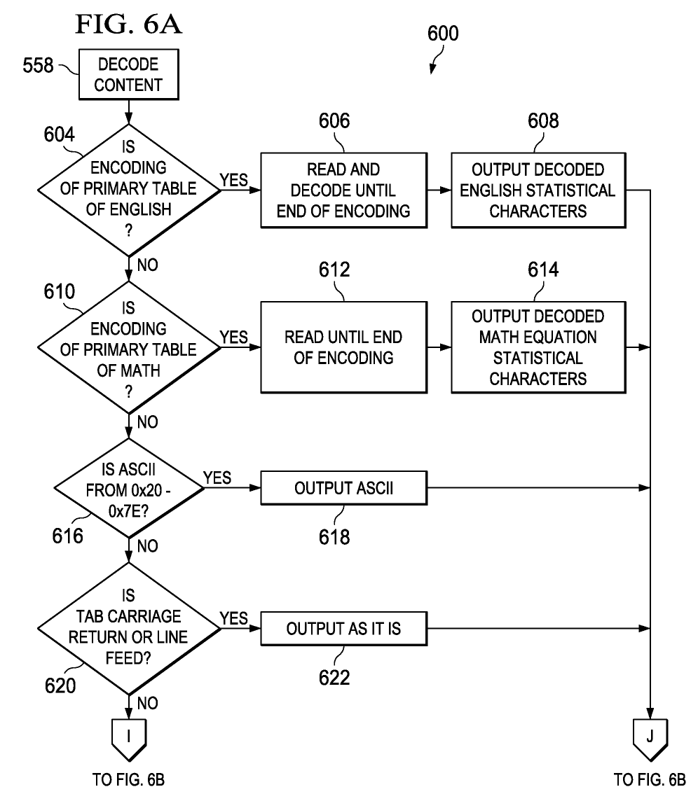

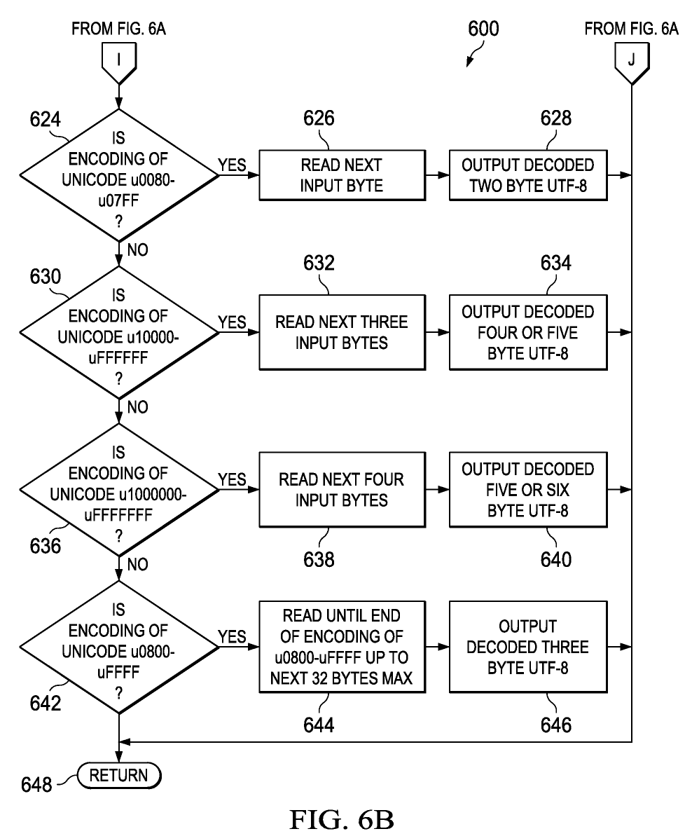

Returning to step 534. If the command byte is not indicative of a start of attribute (“0×0F”), the method proceeds to step 546. At step 546, a determination is made whether the command byte contains data indicative of and end of tag (i.e., “0×0E”). If the command byte contains data indicative of and end of tag, the method 500 proceeds to step 548, wherein the next byte is read. This byte provides the location of the tag in the look-up table. From step 558, the method 500 proceeds to method 600 of FIGS. 6A and B.

At step 550, after the byte is read, the tag is located in the look-up table, decoded, and output as the end of that tag. Thereafter, the method proceeds to step 504. If the command byte does not contain data indicative of and end of tag, then that is an indication there may be content (i.e., non-tag) that needs to be decoded and the method proceeds to step 558 where that code is decoded in method 600.

FIGS. 6A and B depict an embodiment of a flow diagram of a method 600 for decoding and/or decompressing encoded data. Method 600 utilizes the command bytes depicted in FIG. 1A to determine how to decode/decompress the data. When examining FIGS. 6A and B, a reader is encouraged to juxtapose FIGS. 4A and B and FIGS. 6A and B. The method 600 begins at step 558 and proceeds to step 604.

At step 604, method 600 determines whether the character is contained within Table “A”, encoding of primary table of English. If the encoding is of primary table of English, the method 600 proceeds to step 606. At step 606, characters are read and decoded until the encoding, for example, until A or AA is found. Thereafter, the method proceeds to step 608, wherein the output is decoded. From step 608, the method 600 proceeds to step 648 where it returns to method 500. If the encoding is not primary table of English, the method proceeds from step 604 to step 610.

At step 610, the method 600 determines whether the character is a primary table math equation, for example, whether encoding for the character is found in Table “F”. If the character is a primary table math equation, the method 600 proceeds to step 612. At step 612, characters are read until the end of Table “F”, for example, until F or FF is found. The method 600 proceeds to step 614, wherein the mathematical sequence is decoded using Table “F” and proceeds to step 648. If the character is not a primary table math equation, the method proceeds from step 610 to step 616.

At step 616, method 600 determines whether the character falls within the 7 bit ASCII 112 range. If the character falls within the 7 bit ASCII 112 range, the method proceeds to step 618, wherein the character is decoded from ASCII (for example, into an upper case English character). The method 600 proceeds from step 618 to step 648. Otherwise, the method 600 proceeds to step 620.

At step 620, the method 600 determines whether the character is a carriage return, tab, or line feed. If the character is a carriage return, tab, or line feed, the method 600 proceeds to step 622, wherein the character is output as is. Thereafter, the method 600 proceeds to step 648. If, at step 620, the character is not a carriage return, tab, or line feed, the method proceeds to step 624.

At step 624, the method 600 determines whether the character is within the Unicode u0080-u07FF range. If the character is within the Unicode u0080-u07FF range, the method proceeds to step 626. At step 626, the next byte is read, which may result in a two (2) byte output. Thereafter, the method 600 proceeds to step 628, wherein the output is decoded and is 2 bytes. The method 600 proceeds to step 648. If the character is not within the Unicode u0080-u07FF range, the method 600 proceeds from step 624 to step 630.

At step 630, the method 600 determines the character falls within Unicode u10000-uFFFFFF. If the character falls within Unicode u10000-uFFFFFF, the character is decoded and, at step 632, the next 3 bytes are read. Thereafter, at step 634, a decoded output is generated which is 4 or 5bytes in length. After decoding, the method 600 proceeds to step 648. If the character does not fall within Unicode u10000-uFFFFFF, the method 600 proceeds from step 630 to step 636.

At step 636, the method 600 determines whether the character falls within u1000000-u7FFFFFFF. If the character falls within u1000000-u7FFFFFFF, the method proceeds to step 638, wherein the next 4 bytes are read. At step 640, a decoded output is generated which is 5 or 6 bytes long. After decoding, the method 600 proceeds to step 648. If the character does not fall within u1000000-u7FFFFFFF, the method proceeds from step 636 to step 642.

At step 642, the method 600 determines whether the character falls within the Unicode u0800-uFFFF range. If the character falls within the Unicode u0800-uFFFF range, the method 600 reads the encoding of the u0800-uFFFF up to a maximum of the next 32 bytes. Thereafter, at step 646, a decoded output is generated as 3-byte UTF-8 character(s), which in length may be up to 16 characters or 48 bytes. Thereafter, the method proceeds to step 648.

FIG. 7 depicts an exemplary high-level block diagram of coding/decoding computer system 700. FIG. 7 depicts a general-purpose computer 700 suitable for use in performing the methods of FIGS. 2, 3A and B, 4A and B, 5A and B, and 6A and B. The general-purpose computer of FIG. 7 includes a processor 706, a memory 708, support circuit 704 and input/output (I/O) circuits 702.

The processor 706 may comprise one or more conventionally available microprocessors. The microprocessor may be an application specific integrated circuit (ASIC). The support circuits 704 are well known circuits used to promote functionality of the processor 706. The support circuits 704 include, but are not limited to, a cache, power supplies, clock circuits, and the like. The memory 708 is any computer readable medium. The memory 708 may comprise random access memory, read only memory, removable disk memory, flash memory, and various combinations of these types of memory. The memory 708 is sometimes referred to as main memory and may, in part, be used as cache memory or buffer memory. The memory 708 includes programs 710 and conversion module 712.

As such, the processor 706 cooperates with conventional support circuitry 704 in executing the software routines 710, such as, a compression module and/or decompression module, stored in the memory 708, such as, the process steps discussed herein as software processes may be stored or loaded to memory 708 from a storage device (e.g., an optical drive, floppy drive, disk drive, etc.) and implemented within the memory 708 and operated by the processor 706. Thus, various steps and methods of the present invention can be stored on a computer readable medium.

The I/O circuitry 702 may form interface between the various functional elements communicating with the general-purpose computer 700. I/O circuits 702 may be internal, external or coupled to the computer system 700. For example, in the general-purpose computer 700 communicates with other devices, such as, a computer, storage unit, and/or handheld device, through a wired and/or wireless communications link for the transmission of compressed or decompressed data.

FIG. 7 depicts a general-purpose computer that is programmed to perform various control functions in accordance with the present invention, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

Aspects of compression disclosed herein may not result in a compressed file that is larger than the uncompressed derivative file. Some of the benefits of the material disclosed herein include, but are not limited to, an encoding of Unicode characters more efficiently than keeping characters in the UTF-8 format, compression that does not require a separate output buffer (may allow the compression directly into an input buffer with minimal temporary variables/buffers), and a compression method that uses relatively less processing power and memory than other compression methods. In addition, the compression scheme can, in various embodiments, be installed, utilizing software, on personal computers.

Although aspects herein are described as being incorporated into a handheld device, such as, a calculator, such a description is not intended in any way to limit the scope of this disclosure. It is appreciated that aspects disclosed herein may be incorporated into other device, such as, other handheld devices and/or non-hand held devices, computers, and systems.

While the foregoing is directed to embodiments of the present invention, other and further embodiments of the invention may be devised without departing from the basic scope thereof, and the scope thereof is determined by the claims that follow.

We claim:

1. A method comprising:
(a) retrieving Extensible Markup Language (“XML”)-Unicode Transformation Format 8 (“UTF-8”) data;
(b) confirming XML-UTF-8 data in a proper format;
(c) converting a prolog located within said XML-UTF-8 data;
(d) initializing a tag and attribute lookup table;
(e) comparing a current character to a plurality of multi-character patterns;
(f) determining whether said current character can be converted to a multi-character pattern in said plurality and Unicode;
(g) converting said current character to one of ASCII and Unicode when said current character cannot be converted to said multi-character pattern in said plurality;
(h) comparing at least one subsequent character to said plurality of multi-character patterns to determine conversion of at least the current character when said current character can be converted more than one way; and
(i) determining whether there are more characters.

2. The method of claim 1 further comprising repeating steps (e)-(h) until all characters have been converted.

3. The method of claim 1 further comprising:
(k) transmitting said converted prolog and characters towards at least one of a remote storage device, a remote computer, a handheld device, and memory.

4. The method of claim 1 further comprising:
(k) converting said compressed characters to XML-UTF-8.
